(19) United States
(12) Patent Application Publication
(10) Pub. No.: US 2009/0026683 A1
(43) Pub. Date: Jan. 29, 2009

(54) Bayer machine tool pallet systems

(76) Inventors: Jack Leon Bayer, Phoenix, AZ (US); Scott Leon Bayer, Scottsdale, AZ (US)

Correspondence Address: JACK BAYER, 5150 N 24 St, Phoenix, AZ, 85016, US

(21) Appl. No.: 12/215,834

(22) Filed: Jun. 30, 2008

Related U.S. Application Data
(60) Provisional application No. 60/961,827, filed on Jul. 24, 2007.

(51) Int. Cl. B23Q 3/00

(52) U.S. Cl. 269/305

(57) ABSTRACT

This patent relates to a system for rotating work pieces about a horizontal center line so that one or more sides can be machined with out the need of re-clamping. Pallets or log pallets may be used for holding work pieces so the pallets with work pieces can be removed from the machine for parts handling or set-up. Related improvements are described: A rotary table that reduces angular error caused by off center weight, protection from damage caused by inadvertent crash impact, protection from pallets falling from inadvertent unclamping and improved cleaning of pallet locating surfaces. An off machine parts loading index station that prevents inadvertent release of the pallet and provides the optimum ratio between the manual crank and the pallet rotation. A powered actuator that can be used with means for transferring pallets between the machining center and index stations or index and support stations that are mounted to mobile carts.

This patent relates to a Provisional patent application filed Jul. 24, 2007. (Application No. 60/961,827)

### BACK GROUND OF THE INVENTION

The Utility patent application is the same as the Provisional Application with the exception of improved drawings and description.

This invention relates to the improvements needed to provide a machining system that rotates work pieces around a horizontal center line for machining. This system may be adapted to commercial machining centers.

### DESCRIPTION OF PRIOR ART

Horizontal machining centers are normally used to rotate work pieces around a vertical centerline. Their spindle rotates around a horizontal center line. A structure shaped like a tombstone is fixed at one end. It is rotated to expose all sides to the spindle. Work pieces are mounted to vertical the sides of the tombstone for machining. All motion of a machining center, X, Y, Z and rotary axis is controlled by a special computer that can be programmed to machine work pieces. The features of a part can be machined with little or no operator intervention.

Work piece loading and un-loading is normally accomplished by an operator. System rigidity, accuracy and ease of work piece loading and un-loading is a fundamental need.

Tombstones are supported at one end. Logs are supported at both ends. Compared to a tombstone supported at one end a log supported at both ends is 35.8 times more rigid. While it is easy to support both ends of a horizontal log, it is very difficult to support both ends of a log or tombstone when rotated about a vertical centerline.

Logs and tombstones may be attached to devices called pallets that can be removed from the machining center for work handling or other reasons.

A horizontal log pallet system was developed and marketed by the inventors of this invention. This system consisted of a rotary table with means for clamping a pallet and a tail stock for supporting one end of a log pallet. An index station was developed for manual off machine pallet indexing to facilitate work piece loading and un-loading. The pallets were manually transferred from a cart supported index station and log support station, across a gap to a rotary table and tail stock.

### SUMMARY OF THE INVENTION

This invention relates to an improved rotary table, pallet rotary table, tail stock, index station and a powered on/off actuator and a powered pallet rotary table bridge extender. Inter locks are included to prevent inadvertent pallet dropping from the pallet rotary table and index station.

### DESCRIPTION OF THE DRAWINGS

FIG. 1 is an overall view of a pallet rotary table system including an on/off pallet actuator and tail stock.

FIG. 2 shows a cart with an index station, support station and a log pallet.

FIG. 3A shows a front view of a pallet rotary table with partial sections of a worm back lash removal system.

FIG. 3B shows a section taken thru FIG. 3A showing means for rotation, pallet clamping and a split shaft worm gear locking device and means for resisting inadvertent crash impact.

FIG. 4 shows a partial section of a tail stock engagement used to support one end of a log pallet. It shows a partial section of the tail stock taken thru FIG. 1

FIG. 5A shows a front view of an index assembly.

FIG. 5B is a partial section showing interlocks that prevent inadvertent release of a pallet from the index assembly.

FIG. 5C shows the crank side of the index station.

FIG. 6A shows a partial view of gears used to increase the angular ratio between the crank and pallet.

FIG. 6B is an end view of FIG. 6A

FIG. 7A shows a pallet on/off actuator in its retracted position and engaged to a pallet that has been un-clamped from a pallet rotary table.

FIG. 7B shows the extended on/off actuator.

FIG. 8A shows a section of the on/off actuator taken thru FIG. 8C

FIG. 8B shows a section taken thru FIG. 8C.

FIG. 8C is a top view of the on/off actuator.

FIG. 9A shows an on/off actuator in its retracted position and engaged to a flat pallet.

FIG. 9B is a partial view of a pallet clamp with the pallet removed and the on/off pallet actuator extended.

FIG. 10A shows a pallet rotary table bridge with two extensions, one for closing a gap between the rotary table bridge and an index station and the other to align the index station with the rotary table bridge.

FIG. 10B shows a front view of FIG. 10A

FIG. 10C is a side view of FIG. 10B showing an air or hydraulic cylinder used for actuating the extensions.

FIG. 11A is an end view showing A roller rail extension combined with a tail stock.

FIG. 11B is a front view of FIG. 11A.

### DESCRIPTION OF THE PREFERRED EMBODIMENT

For the purposes of promoting an understanding of the invention, reference will now be made to the embodiments illustrated in the drawings and specific language will be used to describe the same. It will nevertheless be understood that no limitation of the scope of the invention is thereby intended, such alterations and further modifications in the illustrated devices, and such further applications of the principles of the invention as illustrated therein being contemplated as would normally occur to one skilled in the art to which the invention relates.

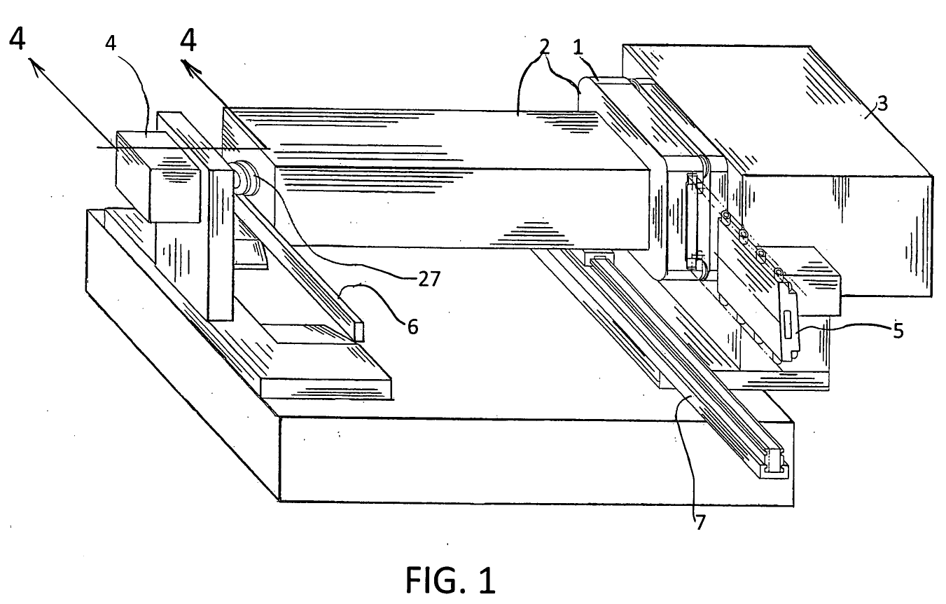

This invention relates to a system that can be used with a machining center FIG. 1 for rotating work pieces, pallets 1 or log pallets 2 about a horizontal centerline so that work pieces fixed a platen or to one or more sides of a pallet or log pallet can be machined on one or more sides.

A pallet rotary table supports a pallet 1 or log pallet 2 at one end and accurately rotates it as controlled by the machining center computer axis drive motor. The pallet rotary table 3 is provided with a system for powerful and accurate clamping and unclamping a pallet so it can be removed from the machining center for various reasons.

A tail stock 4 supports the log at the end opposite the pallet rotary table. A bridge 5 is used to support the pallet during pallet transfer to and from the pallet rotary table. The bridge and a roller rail 6 is used to support a log pallet at both ends for transfer to and from the machining center to a cart.

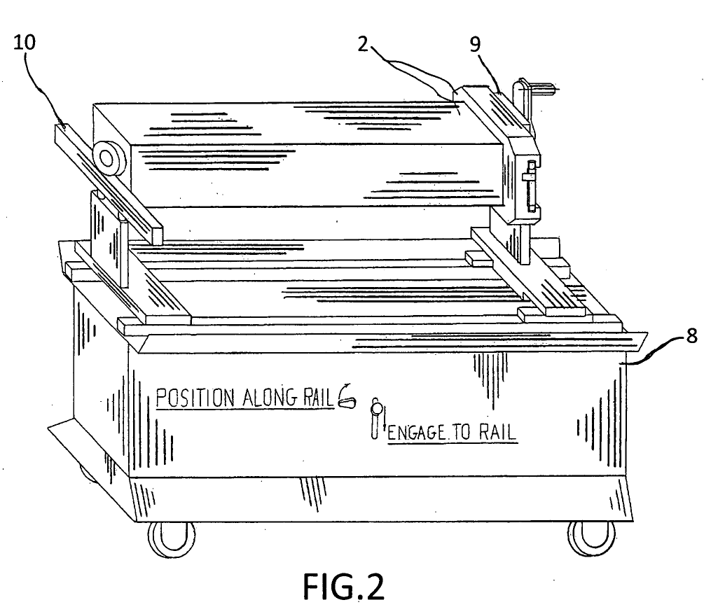

The cart 8 FIG. 2 may be laterally (Y AXIS.) fixed to the machining center but free to move along a longitudinal (X) axis and held at certain locations to receive a pallet or log pallet from the machining center. The cart is easily decoupled from the machining center and moved to any location for work piece handling, set-up or storage. Pallet transfer to and from the cart may be manual or by an on/off actuator 7 FIG. 1. One or more index stations 9 may be located on the cart 8 for receiving a pallet and rotating or indexing it about a horizontal centerline to provide operator access to all sides of the pallet for work piece handling. One or more support stations 10 may be positioned on the cart to support the end of a log pallet.

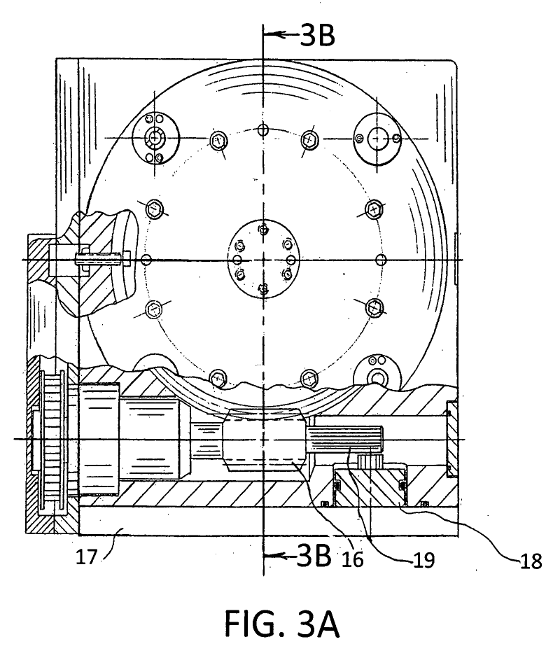

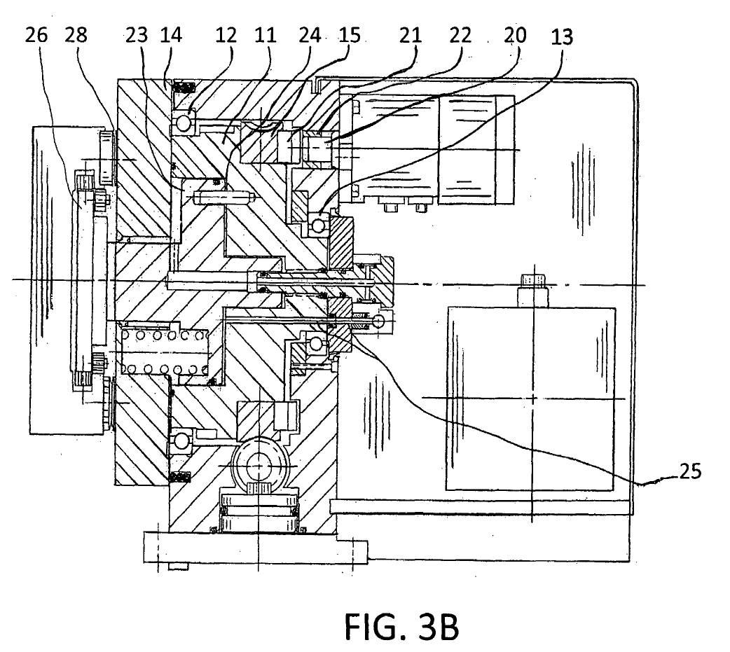

FIG. 3B A rotary table consists of a shaft 11 rigidly supported by ball bearings 12 and 13. One end of the shaft consists of a structure called a platen 14 which may be adapted to hold work pieces or clamp pallets to.

### Description of Improvements

The rotary table is provided with a separate base 17. This facilitates the inclusion of customized bases most suitable for various machining centers.

FIG. 3A A brake is used to increase angular rigidity after rotary motion has stopped. An earlier designed brake consisted of an air piston that engaged the outer diameter of the worm and forced it against the worm gear to remove backlash and resist rotary motion of the worm gear.

An improved brake applies air piston 18 force against a long extension 19 of the worm shaft in order to create leverage that increases the brake force. The smaller diameter of the extension reduces angular error caused by contact by the actuating piston 18. Angular force and thus angular error caused by the piston contact with the smaller diameter shaft extension 19 is reduced by the ratio of the diameters of the larger worm and the smaller extension shaft.

FIG. 3B Air is supplied to the front side of the clamp piston 23 to add to the spring force used to clamp a pallet against four seats 28.

Cleansing the seats 28 was improved by providing sufficient air pressure on the back 24 side of the clamp piston to exceed the spring force and air pressure force against the front side of the clamp piston to unclamp the pallet. This causes the air on the front side of the piston to rapidly exhaust between the seats as they separate. The large volume of air flowing thru the large seat separation area creates a high velocity, large volume of air that is very effective for removing contamination around the seat area. This assures accurate relocation of the pallet.

FIG. 3B A locking device or shot pin is used to prevent rotary motion every 90 degrees. This is used as a quadrant reference and increases angular rigidity and angular accuracy at those locations. The locking device consists of a split shaft 20 that advances thru a bushing 22 and engages matched tapers of a tapered block 21. This causes the split shaft 20 diameter to expand against the inside of the bushing 22 in order to remove all clearance.

This was improved by allowing the tapered block 21 to slide with respect to the worm gear 15 at a predetermined force to prevent rotary table angular crash impact damage. The tapered block 21 is bolted, not pined, to the worm gear 15. Openings are provided in the rotary table housing to provide access for convenient re-adjustment of the tapered block 21 while the split shaft is engaged, to assure accurate adjustment.

Further improvement enabled impact energy to be absorbed by slippage between the shaft 11 and worm gear 15. This can occur at any angular position of the rotary table. The worm gear 15 is bolted to the shaft 11, not pined so predetermined force can cause slippage. Openings are provided in the rotary table housing to provide access for the worm gear adjustment while the split shaft 20 is engaged with one of the tapered blocks 21 to assure accurate adjustment of the worm gear. The predetermined slippage force is controlled by the torque applied to the tapered block 21 and worm gear 15 fasteners.

The pallet rotary table clamps the pallet against four seats 28 that are accurately located on the platen 14. Air and spring pressure are used on the front side of the clamp piston 23 to clamp the pallet. Air pressure that is used to unclamp the pallet is applied to the back side 24 of the piston 23.

This was improved by routing the unclamp air flow thru two holes 25 that are only aligned to transmit air when the top surface of the pallet clamp 26 is horizontal and it is safe to unclamp the pallet with out it falling from the rotary table.

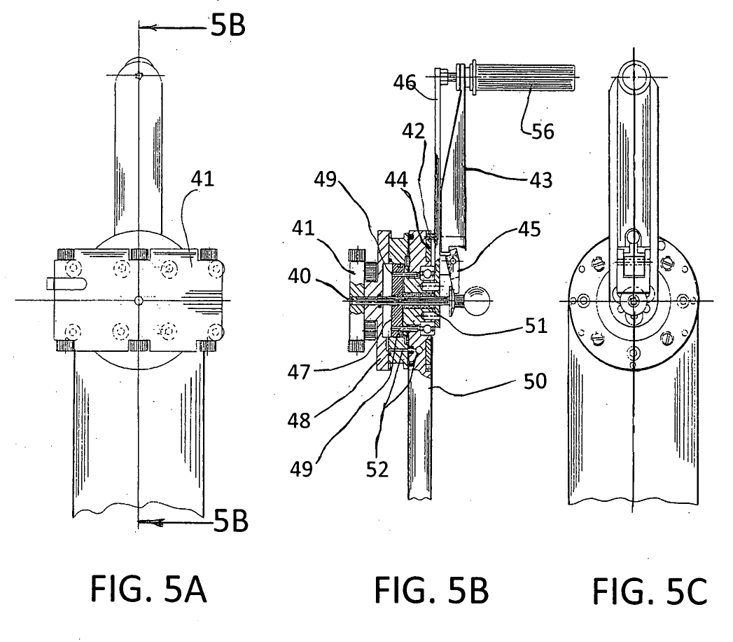

FIG. 5A Shows an index station 9, located on a cart 8 FIG. 2 for manually rotating or indexing a pallet for off machine work parts handling. A pallet transfer lock pin 40 engages the pallet 1 to prevent the pallet from sliding off the rail 41. When the rail 41 is rotated beyond a certain angle, the pallet transfer lock pin 40 prevents gravity from causing the pallet 1 to fall from the rail 41. Failure to engage the pallet transfer lock pin 40 when the rail is rotated could be hazardous to personnel and equipment. A rotational lock pin 42 is used to stop the rail rotation. Manual rotation is accomplished by disengaging the rotational lock pin 42 by impacting it with the lever 43 to extract it from the lock ring 44 and thus enable rotation of the rail 41 to the desired location. The rotational lock pin is re engaged by reverse action of impacting it with the lever 43.

This was improved by providing a Linkage 45 between the pallet transfer lock pin 40 and the rotational lock pin 42 so that the pallet transfer lock pin 40 must be engaged with the pallet if present, before the rotational lock pin 42 can be disengaged from the lock ring 44 in order to rotate the rail 41. Thus, rotation is accomplished by grasping the crank 46 handle 56 with one hand and axially moving it to disengage the rotational lock pin and then rotating it to the desired location then re engaging the rotational lock pin by axial motion of the handle.

This is further improved by providing a second interlock to prevent the operator from inadvertently retracting the pallet transfer lock pin 40 when the pallet could fall from the rail 41. The pallet transfer lock pin 40 is attached to a piston 47 that is located in a bore provided by the hub 48. Two pins 49 are located by the piston 47. These pins 49 must project thru holes located in the hub 48 and align with holes located in the fixed structure of the tail stock 50 when the pallet transfer lock pin is disengaged from the pallet. This can only occur when the rail 41 is rotated to a horizontal position. Only then can the pallet transfer lock pin be retracted and the pallet be transferred from the rail 41.

Automatic means may be used for disengaging the pallet transfer lock pin 40 and releasing the pallet for transfer.

FIG. 5B shows a section of the index station with the pallet transfer lock pin 40 disengaged so that the pallet can be transferred to or from the machine. The pallet transfer lock pin must be disengaged and held against spring pressure to release the pallet.

The piston 47 may disengage the pallet transfer lock pin by compressed air passing thru holes 52 and acting on the piston 47 when the rail 41 is in a horizontal position. This is required in the automatic pallet switching mode. Air can only be supplied to the piston 47 when the passages 52 are aligned when the top surface of the rail 41 is horizontal.

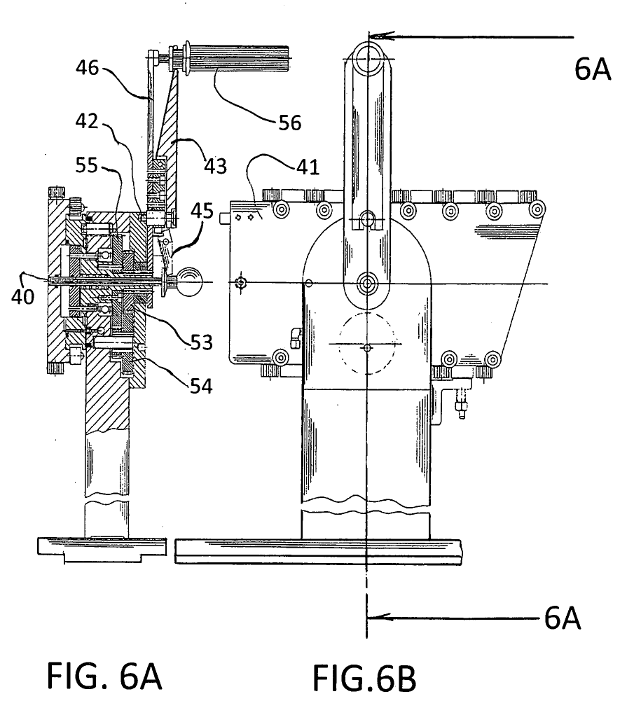

FIG. 6 shows the application of gears 53, 54, and 55 used to change the ratio between the hand crank and the rail 41. This is necessary when very heavy or large pallets must be indexed.

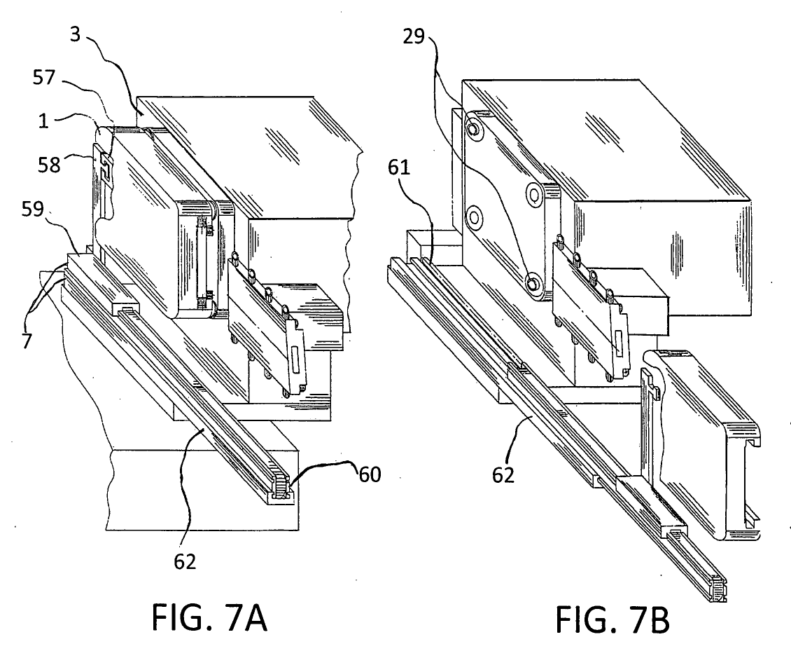

FIG. 7A shows an on/off actuator used for transferring pallets 1 and or log pallet 2 to and from a machining center. The actuator is shown retracted and engaged to a pallet that has been unclamped from the rotary table. When the pallet is unclamped from the rotary table 3 it is moved away from the seats 28, disengaged from the locaters 29 and the C-section 57 that is fastened to the pallet 1 is engaged with the—T-section 58 that is fastened to the on/off slide 59. When pressure is applied to the hydraulic cylinder 61 FIG. 7 B it causes the guide bar 60 to extend beyond the on/off actuator base 62 which in turn causes the displacement of a flexible band 63 that causes the on/off slide 59 to extend an equal distance along the guide bar 60. This causes the pallet 1 or log pallet 2 to move from the rotary table located on a machining center to an index station 9 that is located on a cart 8, FIG. 2. The on/off actuator must be short enough to fit within the machining center enclosure but provide sufficient travel to transport the pallet to a cart. When the pallet is on the cart, the T-section is disengaged from the C-section 58 by a small longitudinal displacement of either the cart or rotary table. Now the pallet is free to be rotated by the index station or be relocated by the cart. The pallet is transferred to the machining center and rotary table in a similar manner.

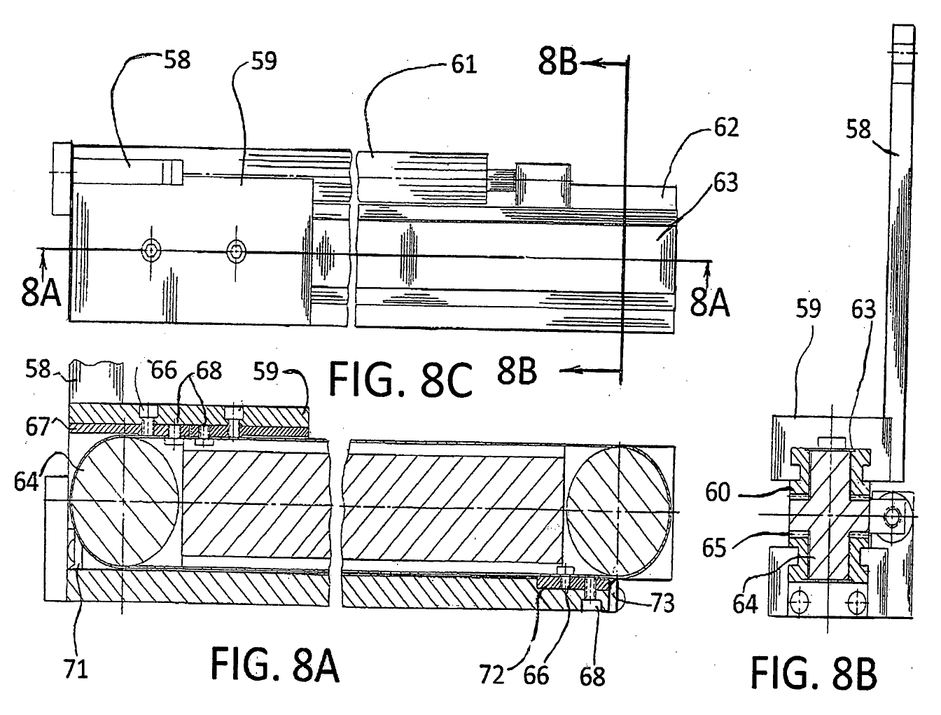

The on/off actuator is further described by FIG. 8A. A flexible band 63 is bolted 68 to a fixed bar 72 which is bolted 66 to the on/off actuator base 62. The flexible band 63 wraps around rollers 64 located at each end of the on/off actuator base 62. The rollers 64 are supported by bearings 65. The flexible band 63 ends are bolted 68 to adjusting bars 67 that are bolted 66 to the under side of the on/off slide 59. The adjusting bars are used to provide the flexible band 63 location and tensioning. The flexible band 63 slides in openings provided by the guide bar 60. This excludes entrance of foreign matter from both sides of the flexible band into the on/off actuator. A hydraulic cylinder 70 is attached at one end of the on/off actuator base 62 and is attached at its rod end to the guide bar 60. When the guide bar 60 is displaced by the hydraulic cylinder 70 the flexible band 63 causes the on/off slide 59 to travel a total distance of twice the travel of the guide bar 60. This accounts for a long travel provided by a short actuator. Seals 71 and 73 are located at each end of the on/off actuator to exclude entrance of foreign matter at the entrance of the flexible band into the on/off actuator base.

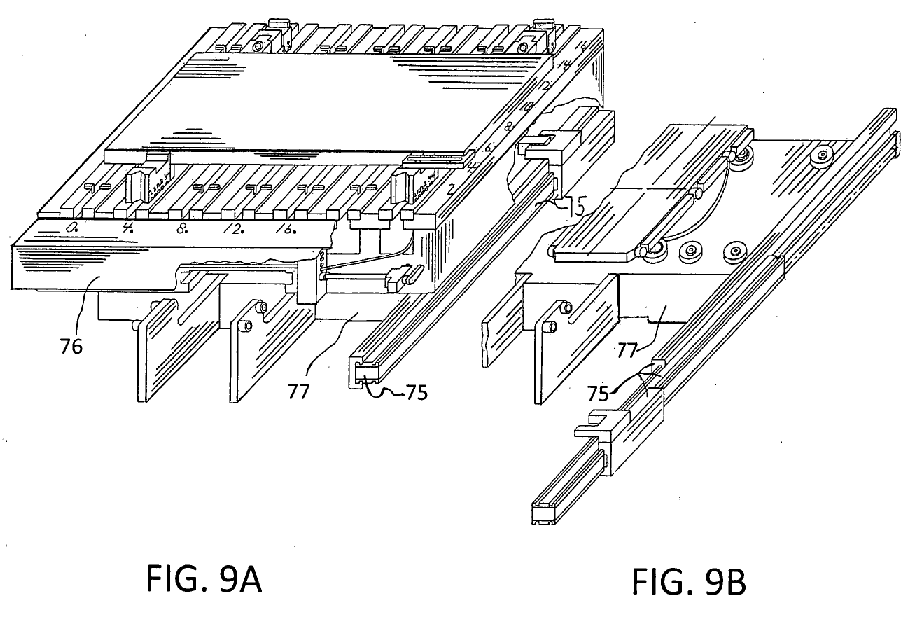

FIG. 9A shows an on/off actuator with slight modification 75 and is used for transferring a flat pallet 76 to and from a flat pallet clamp 77 located on a machining center.

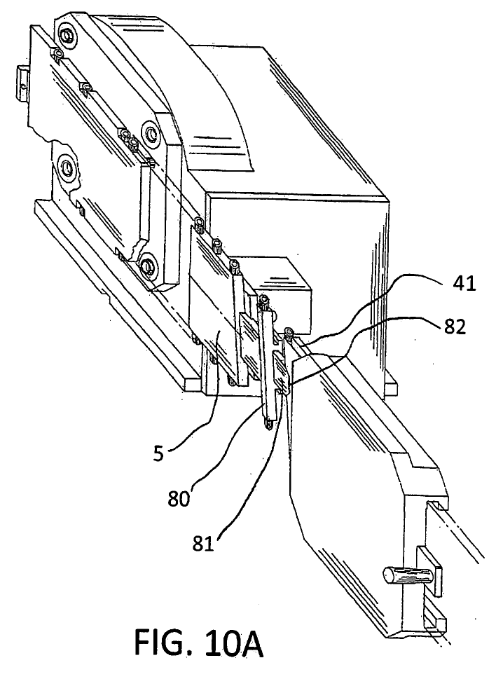

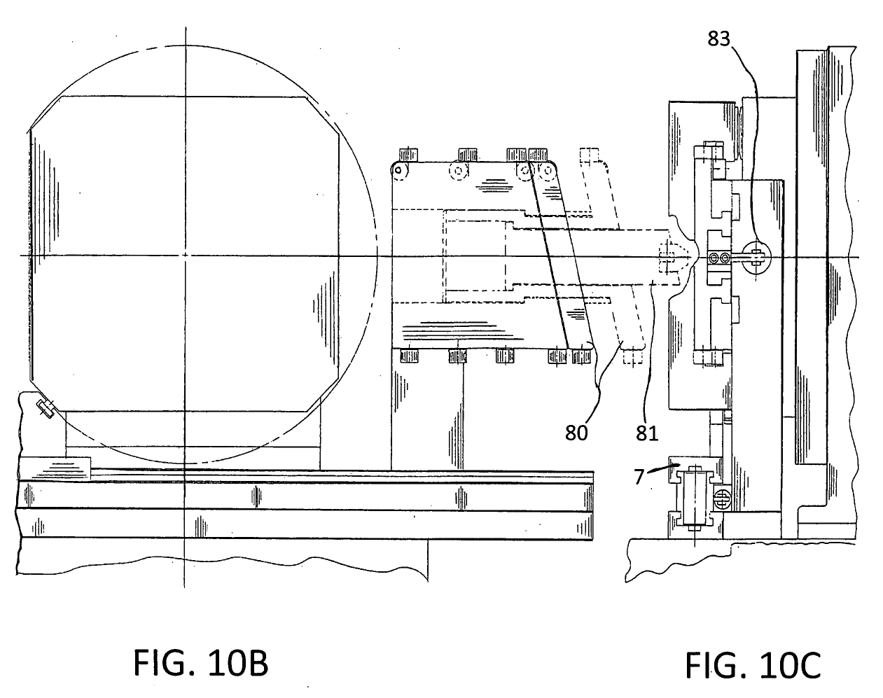

FIG. 10A When a pallet 1 or log pallet 2 is transferred to or from a machining center from a cart, it must pass over an opening that is necessary to accommodate the machining center enclosure doors. Another problem encountered during pallet transfer is vertical misalignment caused by the pallet weight shift from the machining center to the cart. These conditions were corrected by the following improvements.

FIG. 10A shows two extensions housed by the pallet rotary table bridge 5. The first extension 80, when extended, supports the pallet while crossing over the space provided for the machining center enclosure doors. The second extension 81, when extended beyond the first extension 80, engages the index station rail 41 to vertically align it with the bridge 5. An air or hydraulic cylinder 83, FIG. 10C is used to extend the second extension 81 which in turn extends the first extension 80. Retraction of the extensions is accomplished in reverse order.

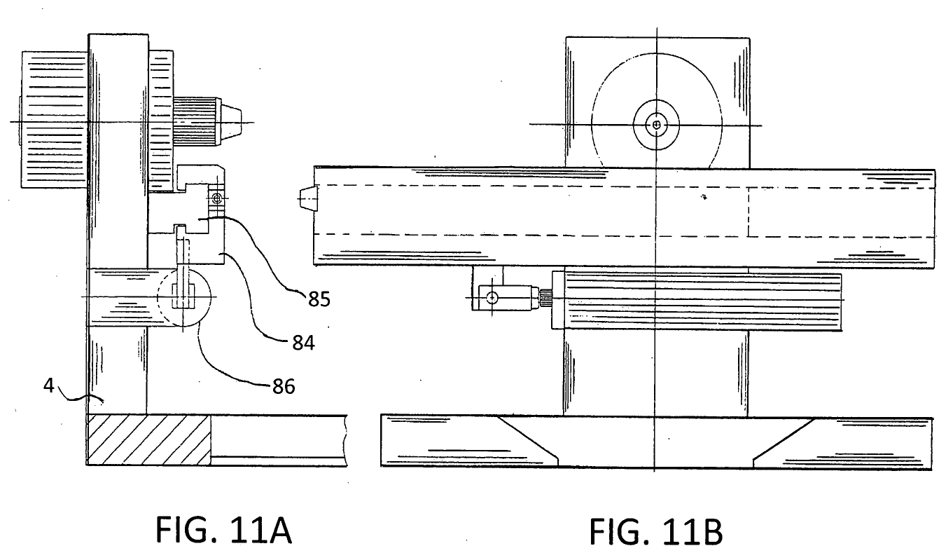

FIGS. 11A and 11B shows a roller rail slide 84 that is guided by a roller rail guide 85 that is mounted to a tail stock 4. The roller rail slide 84 is actuated by an air or hydraulic cylinder 86. It is used to support the log while crossing over the space provided for the machining center enclosure doors and to engage and vertically align the support station located on the cart with the roller rail slide 84.

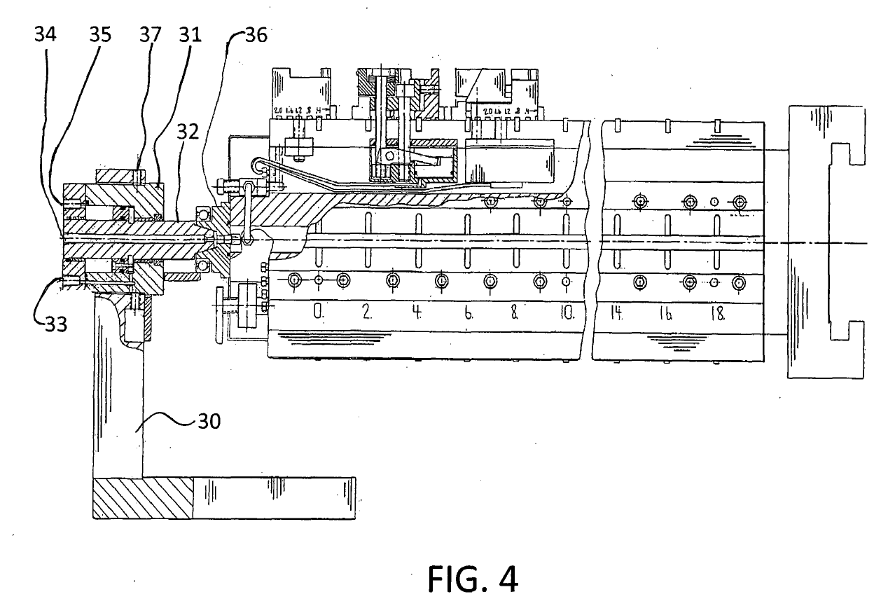

The tail stock is similar to that previously used and marketed, but was improved to combine with the roller rail extension See FIG. 4 and provide a special actuator 31 used for engagement and support of a log pallet end and the ability to transfer air to the log that is stored in the log or pallet and is used for powered work piece clamping. The stored air is used for powered clamping when the pallet or log pallet is removed from its supply of air. The actuator 31 contains a piston 32 and houses it in a much shorter housing 31 that is more easily adjusted to align with the centerline of a log pallet 2. The revised tail stock is combined with a roller retainer 36 that accepts compressed air that flows from the tail stock piston. The roller retainer 36 is fastened to a log pallet and is used to engage with the tail stock piston 32 for support and to transmit compressed air to the log pallet for storage. The compressed air transmitted thru the roller retainer 36 is also used to clean the engagement surface of the tail stock piston 32 and the roller retainer 36 and detect incomplete engagement by measuring abnormal pressure drop.

While the invention has been illustrated and described in detail in the drawings and foregoing description, the same is to be considered as illustrative and not restrictive in character, it being understood that only the preferred embodiments have been shown and described and that all changes and modifications that come within the spirit of the invention are desired to be protected.

What is claimed is:

1. A system comprising a rotary table, or pallet rotary table, tail stock, pallets, log pallets, carts with index stations and support stations and means for manually or automatically transferring pallets or log pallets to and from the pallet rotary table and tail stock mounted on a machining center, to carts located near the machining center;
and improved with means to correct for rotary table angular deflection caused by torque resulting from off center weight and means for clamping and unclamping a pallet to the pallet rotary table with improved capability to clean the mating contact surfaces and means to prevent pallet unclamping when the pallet can fall from the pallet rotary table and means for absorbing angular energy from inadvertent crash impact with the machining center spindle or other parts and a tail stock combined with a powered extension used to assist the transfer of log pallets to and from the machining center; and an index station mounted to a cart, improved with interlocks that prevent inadvertent pallet roll off; and means to provide an improved ratio between the index station hand crank and pallet rotation, and a powered on/off actuator used for transferring pallets or log pallets to and from the machining center; and a powered bridge extension mounted to the pallet rotary table and used to assist pallet transfer to and from the machining center.

2. The improvement of claim 1 where in the rotary table worm is provided with a long extension to increase the force by leverage that results when an air or hydraulic cylinder is caused to act against the end of the extension in order to cause the worm to deflect against the worm wheel and remove backlash and provide resistance to further rotation and reduction of angular error by providing piston contact with a smaller diameter extension shaft.

3. The improvement of claim 1 where in blocks, each with an external taper are bolted, not pined, to a worm gear so that when a split shaft with an internal taper is forced to expand in to a bushing as a result of its forced taper engagement with the blocks, all clearance is removed and the rotary table rotation is locked at this location, and if abnormal impact force occurs the block is designed to slide, not break; and holes are located in the rotary table housing to enable external re adjustment of the block while the split shaft is engaged.

4. The improvement of claim 1 where in the worm gear is bolted, not pined, to the rotary table shaft to provide slippage if abnormal rotary impact force occurs, and holes are located in the rotary table housing to enable re adjustment of the worm gear while the split shaft is engaged.

5. The improvement of claim 1 where in the compressed air flow path used for unclamping the pallet is not aligned and does not transmit the air until the pallet clamp is oriented to prevent the pallet from falling from the rotary table.

6. The improvement of claim 1 where in the compressed air used for clamping the pallet can not exit its chamber until superior unclamping force is used, causing the seats to separate where in the clamping air is instantly expelled to clean the seats.

7. The improvement of claim 1 where in a tail stock used to support the end of a log pallet is improved with a log engagement actuator that can be adjusted to align with the log pallet centerline, and engage to support the log pallet and supply compressed air to clean the engagement surfaces, sense imperfect engagement and to supply compressed air to the log pallet to be stored and used for powered work piece clamping, and combined with a powered roller rail extension used to support the log between the tale stock and support station and also used to vertically align the support station with the roller rail extension.

8. The improvement of claim 1 where in the rotary table bridge is improved with a powered extension or extensions, used to support the pallet between the rotary table and the index station and vertically align the index station with the rotary table bridge.

9. The improvement to claim 1 where in an index station provided with a manual hand crank that can act like a hammer to disengage a rotational lock pin by impact force if needed to enable the pallet to be rotated is improved with a linkage provided between the rotational lock pin and a pallet transfer lock pin and is used to prevent pallet transfer when the rotational lock pin is disengaged and additionally the pallet lock pin can not be disengaged from the pallet unless the index station rail is horizontally positioned for pallet transfer where in the pallet lock pin is fastened to a piston that is provided with pins that must extend thru holes in the stationary index station structure that are only aligned when the rail is oriented for pallet transfer, only then can the pallet pin be disengaged from the pallet manually or by air or hydraulic pressure when the rail is oriented for pallet transfer.

10. The improvement of claim 9 where in the ratio between the hand crank and the pallet rotation can be changed by the application of gears.

11. The improvement of claim 1 where in an on/off actuator of limited length can extend beyond the machining center and position a pallet or log pallet to and from the machine and a cart.

12. The improvement of claim 11 where in the on/off actuator consists of a fixed on/off actuator base that guides and supports a guide bar that when it is partially extended by air, hydraulic or other mechanical means, from the on/off actuator base, an on/off slide supported by the guide bar is moved along the guide bar to increase the extended travel distance of the on/off actuator and where in this motion is caused by a flexible band that is fixed to the on/off actuator base at the band center and both ends wrap around rollers rotationally mounted at each end of the guide bar and the flexible band ends are fastened to the on/off slide so that when the guide bar is moved along the on/off actuator base the resulting displacement of the flexible band causes the on/off slide to traverse along the guide bar in the same direction and twice the distance of the on/off slide bar travel distance.

13. The improvement of claim 12 where in the flexible band is guided and supported by openings provided by the guide bar where in it prevents the inclusion of foreign matter, and seals are located against the band at each end of the on/off actuator to prevent the entrance of foreign material at these locations.

14. The improvement of claim 12 where in a—T-section is attached to the on/off slide and is caused to engage or disengage a mating configuration mounted to the pallet by the displacement of the pallet clamping and unclamping of the rotary table, or when the pallet is located on the index station, disengagement or engagement is achieved by displacement of the cart and index station with respect to the on/off actuator.
